(19) United States
(12) Patent Application Publication
(10) Pub. No.: US 2011/0269468 A1
(43) Pub. Date: Nov. 3, 2011

(54) MOVE SUBSCRIBERS TO SURROUNDING RADIO NETWORK

(75) Inventors: Hans-Olof Sundell, Kalvsund (SE); Roland Gustafsson, Myggenas (SE); Ann-Christine Sander, Vastra Frolunda (SE); Shabnam Sultana, Westmount (CA)

(73) Assignee: TELEFONAKTIEBOLAGET L M ERICSSON (PUBL), Stockholm (SE)

(21) Appl. No.: 13/144,144

(22) PCT Filed: Aug. 24, 2009
(86) PCT No.: PCT/EP2009/060871

§ 371 Date: Jul. 12, 2011

Related U.S. Application Data
(60) Provisional application No. 61/144,358, filed on Jan. 13, 2009.

(51) Int. Cl. H04W 4/00; H04W 36/00

(52) U.S. Cl. 455/436; 455/422.1

(57) ABSTRACT

The present invention relates to a solution for handling closed subscriber groups in a cell and in particular for supporting service continuity for a user when terminating membership of a user in the closed subscriber group in a controlled manner. The present invention is exemplified as a device and method for handling members of a closed subscriber group, i.e. CSG, comprising the steps of obtaining in a mobility management node (105, 300) a signal indicative of exclusion of a user in a closed subscriber group, i.e. CSG, transmitting a message, from the mobility management node to a radio access node (101, 102, 102′, 103, 103′), indicating handover from the cell supporting this CSG to another radio communication network node, receiving in the radio access node the message, and initiating a handover procedure in the radio access node.

### TECHNICAL FIELD

The present invention relates to a solution for handling closed subscriber groups in a cell and in particular for supporting service continuity for a user when terminating membership of a user in the closed subscriber group in a controlled manner.

### BACKGROUND

Technical and business development relating to telecommunications technology is an on going process leading to new standards and solutions for users to communicate wirelessly with each other through networks all over the world. In this process, wireless network access nodes decrease in size and may cover smaller areas of communication range. One such solution is a so called home network access solution.

The concept of a home network access node, as for instance realized in Home NodeB and Home eNodeB in 3GPP standards, has been developed in order to allow for restricted access for certain users, e.g. family members at their home or employees at a company site. Even though they may be installed at home or office sites, these home network access nodes may still be configured and handled by a network operator, for instance for deciding upon an open or closed access mode or for some configurations both open and closed modes, so called hybrid access mode. Operators may for a company client provide differentiated costs for access through publicly available cells and for access through local company cells.

Members authorized to access these home network access nodes belong to a so called Closed Subscriber Group (CSG). A user may belong to several CSG's at the same time.

When configured for hybrid or closed access mode, the Home access node may be configured to provide access to temporary members of the CSG, for instance family friends at home or consultants at a company site. It is possible to modify a CSG list by removing or adding members to the list. For temporary members of a CSG it may be provided a time limit on access for each member and this time limit is configurable from a control device by an administrator, e.g. a network operator or home network owner. The time limit may be set to different times and may span from minutes to several days or even unlimited access for permanent members of the CSG. When the time period expires, the CSG is no longer available for services for the user, apart from possibly emergency calls or welcoming information or similar information about the CSG or site without further access to external networks. Furthermore, access to the CSG for members may be restricted due to shortage of HNB/HeNB resources and the member may in such a case be diverted from the CSG cell. Terminating a membership using normal procedures will cause the user to loose connection and any application running will be disconnected from the network, e.g. a voice call will be terminated and an Internet connection will be lost.

### SUMMARY

It is therefore an object of the present invention to provide solutions that addresses these problems. This is provided in a mobility management node in a communications network for providing wireless communication. The node comprises a processor, a memory unit, and a communication interface. The processor is arranged to execute instructions, stored in the memory, for obtaining a signal relating to expiration of access to a close subscriber group, i.e. CSG, and transmitting on the communication interface an indication to a radio access node indicating end of access to the CSG.

The signal may be related to a timer providing a timed subscription in the CSG or related to expiration of subscription of the CSG.

The indication may be a handover required message or a handover indication comprised in a release message.

Yet another embodiment of the present invention is provided, a method for handling members of a closed subscriber group, i.e. CSG. The method comprises the steps of: obtaining in a mobility management node a signal indicative of exclusion of a user in a closed subscriber group, i.e. CSG, transmitting a message, from the mobility management node to a radio access node, requesting handover from the CSG to another radio communication network, receiving in the radio access node the message, and initiating a handover procedure in the radio access node.

The radio access node may be one of a Home NodeB, Home eNodeB, NodeB or eNodeB.

The signal indicative of exclusion may be related to a timer, resource handling, or membership of the CSG.

These and other aspects of the invention will be apparent from and elucidated with reference to the embodiments described hereinafter.

With the embodiments of the present invention, the services for the end-user are kept, for example allowing the end-user to continue a voice call or a file down-load, instead of being disconnected and the voice call or file download terminated.

The solution re-uses to a high degree procedures that are already standardized and may be implemented into existing procedures with flexibility and ease.

### BRIEF DESCRIPTION OF THE DRAWINGS

In the following the invention will be described in a non-limiting way and in more detail with reference to exemplary embodiments illustrated in the enclosed drawings, in which:

FIG. 1 illustrates schematically in a block diagram a network according to the present invention;

FIG. 2 illustrates schematically in a signaling diagram a handover scenario according to the present invention; and

FIG. 3 illustrates schematically in a block diagram a device according to the present invention.

### DETAILED DESCRIPTION OF PREFERRED EMBODIMENTS

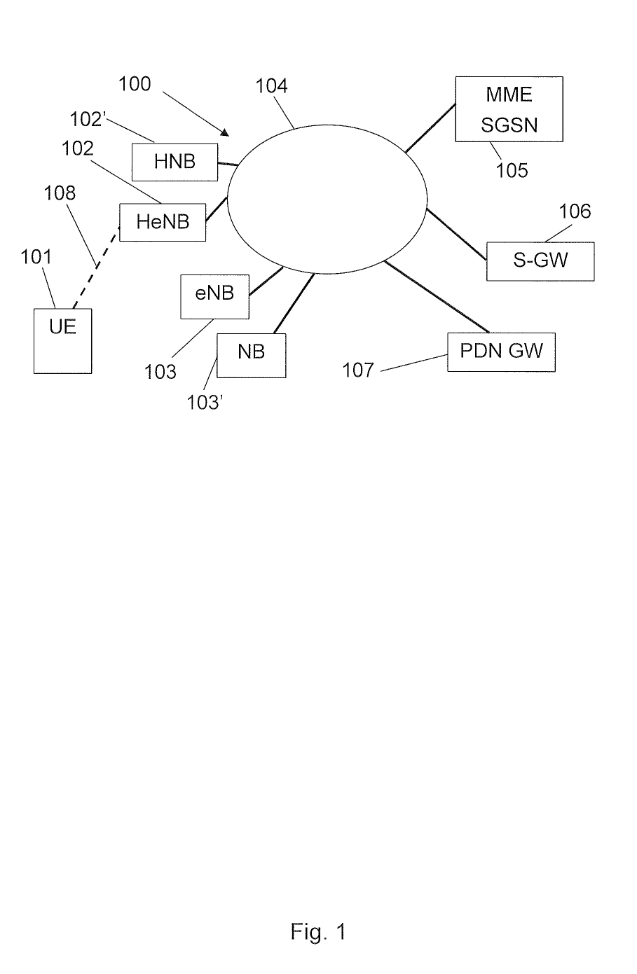

In FIG. 1, reference numeral 100 generally denotes a communications network according to the present invention, providing wireless 108 access for user equipment 101 (UE). The UE connects and communicates with the communication network using a wireless communication standard, for example Long Term Evolution (LTE) based radio standard. The network may be divided into two parts, radio access network (RAN) and core network. In the RAN radio access devices handles access for the UE and facilitates in handover between radio access devices and radio standard protocols. In the case exemplified in FIG. 1, NodeB and eNodeB's 102, 102′, 103, 103′ may handle communication with the UE. In this example the Node or eNodeB are arranged as so called Home NodeB or Home eNodeB's, from now on both of these will be referred to as H(e)NB if not specifically denoted otherwise. The H(e)NB communicates with user equipment belonging to a Closed Subscriber Group (CSG) with membership related to the H(e)NB. A H(e)NB in closed or hybrid mode may be configured to support one Closed Subscriber Group (CSG) Identity per cell and the H(e)NB may support several cells at the same time. The UE may belong to several Closed Subscriber Groups but communicates normally only with one CSG at a time.

Depending on core network configuration, different entities will be handling core procedures; as an example, the core network may comprise a mobility management device, e.g. a mobility management entity (MME), serving GPRS support node (SGSN), or Mobile Switching Centre (MSC) 105 handling e.g. mobility issues. Furthermore, the core network may comprise a serving gateway (S-GW) 106 providing a mobility anchor point. In the core network or in some external core network, if the UE is roaming, a Packet Data Network Gateway (P-GW) 107 may be connected in order to handle charging issues, and connectivity to a packet data network, such as for instance the Internet or an operator specific network. These entities are connected to each other using common packet based communication technology based devices, such as routers and switches connected to each other using e.g. Ethernet or similar network communication protocol interfaces.

Optionally, a HNB/HeNB gateway (GW) (not shown) may be located in the network for handling a plurality of HeNB's—the HeNB GW is located in between the MME and HNB/HeNB's in the network. If a HeNB gateway (GW) is provided, it is perceived as transparent when it comes to communication between a HNB/HeNB and an MME: the HeNB GW appears to the MME as a HNB/HeNB, and the HeNB GW appears to the HNB/HeNB as an MME depending on network configuration. It should be noted that in a network configuration with an SGSN, there is a HNB GW between the HNB and SGSN and in a network configuration with a MME an optional HeNB GW between HeNB and MME. This H(e)NB GW is not shown in FIG. 1.

To be able to continue the service when the UE is in connected mode and the UE must leave the CSG cell, the system may perform a handover-like procedure. This handover procedure will then move the UE to the target cell with substantially uninterrupted services.

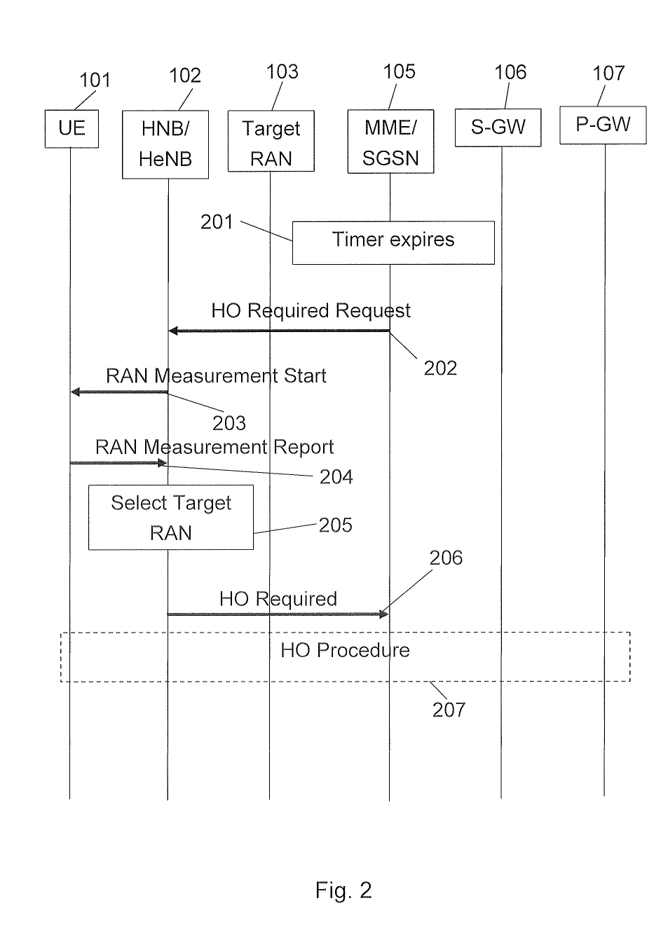

In one embodiment of the present invention, a user is connected to the network 100 in a closed subscriber group (CSG) but for some reason the membership to this CSG is terminated or expires, therefore, the connection of the user need to be handled in an appropriate way. In one scenario the user is only a temporary member of the CSG and the membership is then advantageously controlled by a timer located at an appropriate location in the network; often the timer is located in the core of the network, e.g. with the MME or SGSN 105. The process of handling the termination/expiration of the membership of the CSG is shown in FIG. 2. When the timer expires 201 the MME/SGSN sends 202 a request signal to the RAN radio access device, e.g. the H(e)NB, that a handover is required for the UE 101 of the user. The timer is part of the subscription data that SGSN/MME has received from a Home Subscriber Server (HSS, not shown) earlier, i.e. in an attach procedure. The SGSN/MME sends a request message “Handover Required to non-CSG cell” via e.g. the Iu/S1 interface to the H(e)NB. This message may be sent transparently via any intermediate nodes, e.g. a HeNB GW.

The H(e)NB reacts by transmitting 203 a RAN measurement start signal, informing the UE that it should start taking radio measurements on the surrounding cells in order to identify suitable cell to connect to. Data from this measurement is transferred back 204 to the H(e)NB as a RAN measurement report. The H(e)NB uses the measurement information to select 205 suitable target RAN cell according to suitable standard procedures.

The H(e)NB initiates a standardized handover procedure by sending 206 a message “Handover Required” to the SGSN/MME. This message may be sent transparently via any intermediate nodes, e.g. a HeNB GW. However, if the H(e)NB fails to select suitable target RAN, no “Handover Required” message will be transmitted and the MME/SGSN may take appropriate steps for this situation, e. g. simply terminating membership of the CSG without any handover or facilitating handover to a non LTE based radio network, e.g. where the wireless communication interface is one of WCDMA, CDMA2000, WLAN, WiMAX, GSM, GPRS, or EDGE.

Handover procedure 207 then follows standardized handover procedures as defined in 3GPP TS 23.401 and TS 23.060 for handover to another cell, e.g. E-UTRAN, UTRAN or GERAN. After the handover procedure the UE receives/sends user data via the target RAN, Serving-GW and PDN-GW and to the server(s) on the external network, e.g. Internet. The UE may after handover still have the same CSG Id valid in the subscription.

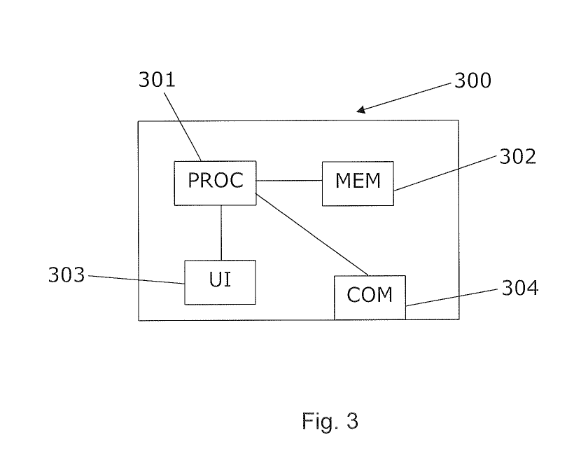

The MME/SGSN 300 comprises as seen in FIG. 3, a processor 301, a computer readable memory 302, a communication interface 304, and optionally a user interface 303 for management of the MME/SGSN. The processor is configured to execute computer program instruction sets stored in the computer readable memory for obtaining information about or determining termination of membership of a CSG, e.g. from a signal from some other device or a timer, for transmitting a signal using the communication interface to a radio access node with a handover required message, e.g. as a specific message or embedded into some other control message as will be discussed below, for receiving on the communication interface a handover required response message with information about target RAN, and for initiating handover procedures according to standardized protocols.

Alternative solutions that may be used in the process of terminating the membership of the CSG may be:
1. Instead of sending the new Handover Required Request message from the SGSN/MME in step 202, the SGSN/MME may send for instance an “Iu Release”/“S1 Release” message with a special cause code or parameter to the H(e)NB. When the H(e)NB receives that message it continues the procedure at step 203 without releasing the Iu/S1 connection.
2. Instead of sending the Handover Required Request from the SGSN/MME in step 202, the SGSN/MME may send a message directly to the UE to inform it to start the measurements on the surrounding cells. The procedure is then continued at Step 204.

Both the UE and the H(e)NB or any other radio access network nodes may be seen as radio access nodes since they both operate in the radio access interface, i.e. communicates using radio signal between each other.

In some network deployments the SGSN is connected to a GGSN, instead of a Serving GW and PDN GW. In those network deployments the handover procedure is according to the 3GPP TS 23.060, which has similar flow logic.

It should be noted that the present invention has been exemplified above with the situation where a user is excluded from a CSG cell and is transferred to a non-CSG cell, i.e. within the meaning of the present invention to another cell being different from the source CSG cell, e.g. to another cell of any kind, for instance to another CSG cell or a public/open cell of any type. Furthermore, a membership may be terminated not only due to expiration of a timer, but it may be terminated for several other reasons, e.g. actively terminated by an administrator, monetary reasons, resource handling, e.g. too many connected to the cell at the same time and it is decided that some members should be excluded to allocate resources, and so on, where the procedures of the present invention is applicable. See for instance FIG. 2, where step 201 is changed to some other termination reason.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims, that the invention may be at least in part implemented by means of both hardware and software, and that several “means” or “units” may be represented by the same item of hardware.

The above mentioned and described embodiments are only given as examples and should not be limiting to the present invention. Other solutions, uses, objectives, and functions within the scope of the invention as claimed in the below described patent claims should be apparent for the person skilled in the art.

### DEFINITIONS

A Closed Subscriber Group identifies subscribers of an operator who are permitted to access one or more cells of the PLMN but which have restricted access (CSG cells).

A HNB is a customer-premises equipment that connects a 3GPP UE over UTRAN wireless air interface to a mobile operator's network using broadband IP backhaul.

A HeNB is a customer-premises equipment that connects a 3GPP UE over EUTRAN wireless air interface to a mobile operator's network using broadband IP backhaul.

A radio access node is a node operating in the radio access area, i.e. it may be a UE or an infrastructure node, e.g. a H(e)NB.

### ABBREVIATIONS

BTS Base Transceiver Station
CSG Closed Subscriber Group
DB Database
EPC Evolved Packet Core
EPS Evolved Packet System
EUTRAN Evolved UTRAN
GERAN GSM EDGE Radio Access Network
GGSN Gateway GPRS Support Node
LTE Long Term Evolution
MME Mobility Management Entity
PDN Packet Data Network
PDP Packet Data Protocol
P-GW Packet data network Gateway (PDN-GW)
RAN Radio Access Network
SGSN Serving GPRS Support Node
S-GW Serving Gateway
UE User Equipment
UTRAN UMTS Terrestrial Radio Access Network

1. A mobility management node for providing wireless communication, comprising:
a processor;
a memory unit;
a communication interface;
wherein the processor is arranged to execute instructions, stored in the memory, for obtaining a signal relating to expiration of access to a closed subscriber group, and transmitting on the communication interface an indication to a radio access node indicating end of access to the closed subscriber group (CSG).

2. The node according to claim 1, wherein the signal is related to a timer providing a timed subscription in the CSG.

3. The node according to claim 1, wherein the signal is related to expiration of subscription of the CSG.

4. The node according to claim 1, wherein the indication is a handover required message.

5. The node according to claim 1, wherein the indication is a handover indication comprised in a release message.

6. The node according to claim 4, where wherein the handover is directed towards a non-CSG cell

7. The node according to claim 4, wherein the handover is directed towards a CSG-cell supporting another CSG Id than the original CSG cell.

8. The node according to claim 4, wherein the handover is directed towards a cell with any type of wireless communication interface.

9. The node according to claim 8, wherein the wireless communication interface is one of WCDMA, LTE, CDMA2000, WLAN, WiMAX, GSM, GPRS, or EDGE.

10. A method for handling members of a closed subscriber group (CSG), comprising the steps of:
obtaining in a mobility management node a signal indicative of exclusion of a user in the CSG; and
transmitting a message, from the mobility management node to a radio access node indicating handover from the CSG to another radio communication network;
receiving in the radio access node the message; and
initiating a handover procedure in the radio access node.

11. The method according to claim 10, wherein the step of obtaining a signal indicative of exclusion relates to a timer.

12. The method according to claim 10, wherein the radio access node is an infrastructure node of a radio access network.

13. The method according to claim 10, wherein the radio access node is a user equipment.

14. The method according to claim 10, wherein the signal indicative of exclusion relates to resource handling.

15. The method according to claim 10, wherein the signal indicative of exclusion relates to an Iu/S1 release event.
